(19) United States
(12) Patent Application Publication
(10) Pub. No.: US 2005/0102197 A1
(43) Pub. Date: May 12, 2005

(54) Message-based referral marketing

(76) Inventors: David Page, Manchester, MA (US); David Shnaider, Concord, MA (US); Claude Sheer, Boxford, MA (US); Tom Simons, Boston, MA (US); Kathleen Goodwin, Cambridge, MA (US)

Correspondence Address: Anthony L. Miele;Miele Law Group, 137 South Main Street, Natick, MA, 01760, US

(21) Appl. No.: 11/001,152

(22) Filed: Dec. 1, 2004

Related U.S. Application Data
(63) Continuation of application No. 09/519,197, filed on Mar. 6, 2000, now abandoned.

(51) Int. Cl. G06F 17/60

(52) U.S. Cl. 705/26

(57) ABSTRACT

Referral marketing allows retail customers to circulate a message recommending a product to a designated set of contacts. The recommendation may be posted with the order or subsequently, after the individual has received the product. The invention may include response-tracking capability that records whether any of the individuals who received recommendations purchase the product and facilitates compensation of the individual by the seller for making the sale.

### FIELD OF THE INVENTION

The present invention relates to electronic commerce, and in particular to referral-based marketing over the Internet.

### BACKGROUND OF THE INVENTION

Traditional retail marketing efforts involve merchant or manufacturer advertising through mass-media outlets, such as television and print advertising. Such efforts are expensive, time-consuming, and offer no guarantee of success. As an alternative, some retail businesses have turned to multi-level marketing, in which merchants hire independent contractors who are paid on a commission basis. These contractors themselves solicit the services of other independent contractors, and receive compensation for a portion of the sales attributable to those individuals. The “grass roots” marketing tiers established in this manner can expand without limit, and as new sellers are recruited, the benefits ultimately inure to the top-level retail business.

Multi-level marketing, while advantageous in reducing advertising costs, nonetheless has numerous shortcomings. First and foremost, it requires the retail business to organize and maintain a widely diffuse sales network and to arrange for product distribution to numerous sellers, thereby bypassing conventional distribution channels and their cost efficiencies. Second, many products (such as large appliances and automobiles, as well as many services) are not amenable to multi-level sales efforts. And finally, without direct control over the sellers themselves, the retailer is unable to prevent sales practices that can seriously jeopardize business goodwill.

What is needed, therefore, is a marketing approach that comports with existing sales and distribution patterns but does not involve the direct expenditures associated with traditional advertising.

### DESCRIPTION OF THE INVENTION

### BRIEF SUMMARY OF THE INVENTION

The present invention utilizes “referral” marketing to tap the efforts of enthusiastic product purchasers in disseminating promotional information. Satisfied purchasers are already predisposed toward product praise, and the invention provides both the opportunity to direct such praise toward those likely to act on it and an incentive, in the form of a reward, for doing so. The invention is easily integrated into established retail sales channels, in particular those configured for electronic commerce.

Accordingly, in a first approach, the present invention facilitates referral marketing by online sellers of goods. The seller integrates the referral-marketing technology of the present invention into its Internet site so that whenever a customer purchases a specific item or service, the customer is accorded the option of attaching a message recommending the purchased product to a “communication circle” of contacts. The recommendation may be posted with the order or subsequently, after the individual has received the product. The invention includes response-tracking capability that records whether any of the individuals who received recommendations purchase the product and facilitates compensation of the individual by the seller for making the sale.

Thus, in accordance with this aspect of the invention, the seller receives and processes orders of products placed remotely by a purchaser via a client machine connected to the Internet. The invention facilitates storage of a database record identifying (i) the purchaser, (ii) a plurality of contacts designated by the purchaser, and (iii) contact information (e.g., e-mail addresses) facilitating communication with the contacts. A server operated by the seller transmits, via the Internet, rendering instructions causing the client machine to render an interface (generally as a web page or pages). The interface allows the customer to designate the items of the order, one or more of the customer's contacts, and a message pertaining to the order. This information is transmitted back to the seller's server, which fulfills the order, transmits the message to the designated contacts, and monitors whether any of the designated contacts subsequently purchases the product. If so, a credit entry is posted in the customer's record.

In a second approach, a company (which may be a seller or an independent marketing firm) offers individuals using its technology the option of picking a list of products they wish to recommend, and sending a promotional message—authored by the individual or by the product seller—to the individual's communication circle. Once again, the invention may include response-tracking capability that records whether any of the individuals who received recommendations have taken action based thereon, and facilitates reward of the individual when this occurs. This capability also provides a useful adjunct for companies whose primary business is to facilitate communication. For example, a message-routing service may deliver customer-supplied messages to designated recipients by any of various means, including conventional or wireless telephone, facsimile transmission, pager, e-mail, postal mail or courier. The present invention allows the service to give the customer the option to create a message (or append a promotion to an otherwise non-promotional message) that may result in a reward to the customer.

In accordance with this aspect of the invention, a server stores a record identifying (i) users, (ii) a plurality of contacts designated by each user, and (iii) contact information facilitating communication with the contacts. A server transmits, via the Internet, rendering instructions for an interface that interface allows a user to select one or more products from a list of products; that list is embedded in the interface rendering instructions or is accessed by means, for example, of a hyperlink. The user designates one or more of the contacts, and selects or writes a message (or a message add-in) pertaining to the selected product(s). The invention causes the message to be transmitted and monitors whether the recipient subsequently purchases the item. If so, a credit entry is posted in the user's database record.

### BRIEF DESCRIPTION OF THE DRAWINGS

The foregoing discussion will be understood more readily from the following detailed description of the invention, when taken in conjunction with the accompanying drawings, in which:

FIG. 1 schematically represents the basic approach of the invention; and

FIG. 2 is a flow diagram illustrating the basic functions of the invention.

### DETAILED DESCRIPTION OF THE PREFERRED EMBODIMENTS

The Internet, which can provide the communication medium of the present invention, is a worldwide “network of networks” that links millions of computers through tens of thousands of separate (but intercommunicating) networks. Via the Internet, users can access tremendous amounts of stored information and establish communication linkages to other Internet-based computers.

Much of the Internet is based on the client-server model of information exchange. This computer architecture, developed specifically to accommodate the “distributed computing” environment that characterizes the Internet and its component networks, contemplates a server (sometimes called the host) that services the requests of a large number of smaller computers, or clients, which connect to it. A server is typically a powerful workstation or mainframe computer, while the clients may be simple personal computers.

The Internet supports a large variety of information-transfer protocols.

The World Wide Web (hereafter simply the “web”) represents one of these.

Web-accessible information is identified by a uniform resource locator or “URL,” which specifies the location of the file in terms of a specific computer and a location on that computer. Typically, a URL has the format http://<host>/<path>, where “http” refers to the HyperText Transfer Protocol, “host” is the server's Internet identifier, and the “path” specifies the location of the file within the server. Each “web site” can make available one or more web “pages” or documents, which are formatted, tree-structured repositories of information, such as text, images, sounds and animations.

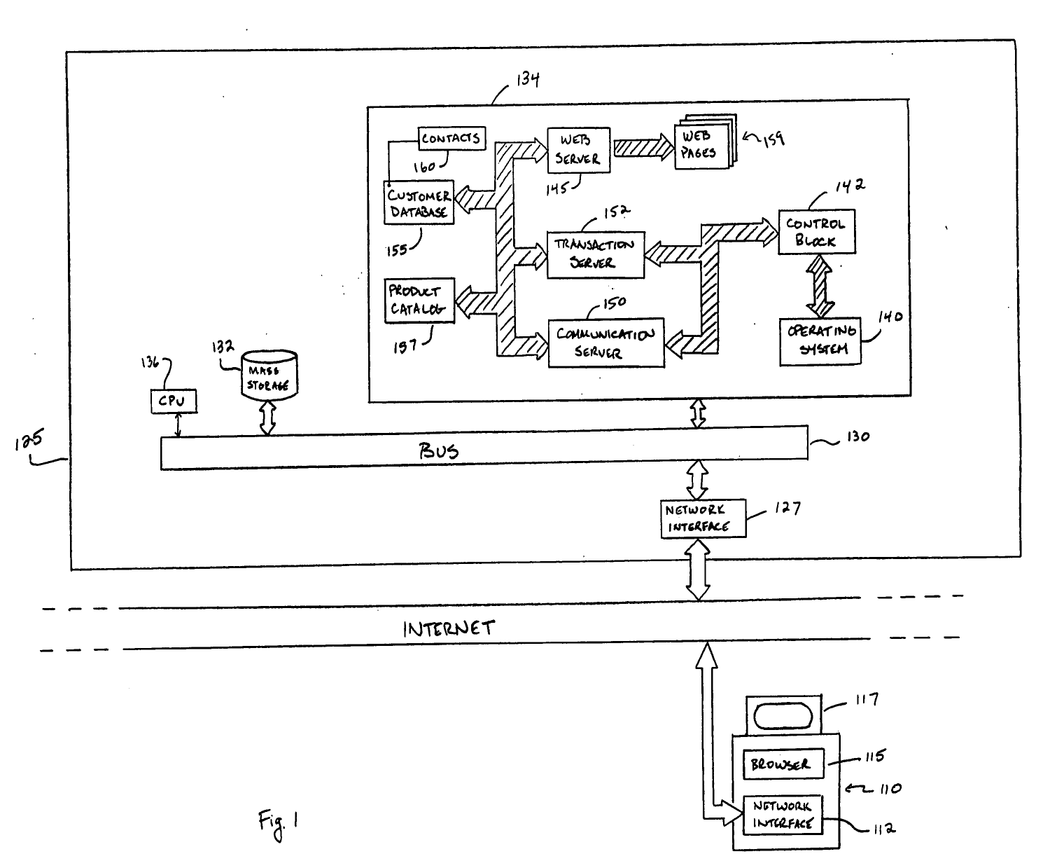

Web functionality is typically implemented on the client machine via a web browser. As shown in FIG. 1, a client system 110, belonging to (or operated by) a message sender or recipient, is implemented as a personal computer having a network interface 112 and, running on the system as an active process, a web browser 115. Network interface 112 connects, generally via telephone dial-up, to a gateway or other Internet access provider. As a result, the client machine 110 becomes a node on the Internet, capable of exchanging data with other Internet computers. (Naturally, computer 110 also contains various conventional components, i.e., system storage, an operating system and a graphical user interface, and a keyboard and/or position-sensing device (e.g., a mouse) for accepting input from the customer. For simplicity of presentation, these are not shown.) Browser 115 controls the content presented on a display 117. With the client connected as an Internet node, the browser utilizes URLs—provided either by the customer or a link—to locate, fetch and display the specified documents. “Display” in this sense can range from simple pictorial and textual rendering to real-time playing of audio and/or video segments or alarms, mechanical indications, printing, or storage of data for subsequent display.

By means of the URL, browser-originated messages reach a server system 125 (which implements the functions of the invention as described below) via the Internet. The browser passes the URL to a protocol handler on server 125, which retrieves and transmits to the client machine 110 rendering instructions defining the requested web page. The browser causes the received information to be cached (usually on a hard disk) on the client computer. A web page may be written in HyperText Markup Language, or HTML, which breaks the document into syntactic portions (such as headings, paragraphs, lists, etc.) that specify layout and contents; and/or in a scripting language such as Java.

Server system 125, which is illustrated in greater detail, may be implemented as a single workstation or as a network of server computers, depending on the activity level and included functionality. For explanatory purposes, server 125 is represented as a single machine that includes a network interface 127 continuously connected to the Internet. Network interface 127 and the other internal components of server 125 intercommunicate over a main bidirectional bus 130 (which may be a physical bus in a single hardware device, or can instead represent a network such as a LAN or a WAN). The main sequence of instructions effectuating the functions of the invention and facilitating interaction among clients, server 125, the Internet, and other modes of communication reside on a mass storage device (such as a hard disk or optical storage unit) 132 as well as in a main system memory 134 during operation. Execution of these instructions and effectuation of the functions of the invention is accomplished by a central-processing unit (“CPU”) 136.

A group of functional modules that control the operation of CPU 136 and effectuate the operations of the invention is shown conceptually as located in system memory 134; once again, however, it should be stressed that this organization is for explanatory purposes. The various modules and servers may indeed be realized as active processes running on a single machine, but functionality may instead be distributed among multiple machines (or processors within a single machine), once again depending on the activity level and included capabilities.

An operating system 140 directs the execution of low-level, basic system functions such as memory allocation, file management, and operation of mass storage devices 132. At a higher level, a control block 142, implemented as a series of stored instructions, manages interaction among the various functional components of the server and ensures proper routing of data thereamong.

Server 125 may capable of communicating with customers in various modes, as explained above, but for purposes of explanation will be considered to communicate primarily by means of the web and electronic mail. Accordingly, a web and e-mail (hereafter “web/mail”) server block 145 receives communications from customers via the web and/or e-mail, and transmits proper responses via a network interface 147. An additional communication server 150 handles other modes of communication (e.g., telephone, facsimile, postal mail) both with the customer and with the customer's referrals, as detailed below. The pattern of interaction with the customer and referrals, and the content of transmissions to client computers, are handled by a transaction server 152. In the illustrated embodiment, server 125 implements a retail electronic commerce enterprise, and therefore has access to various databases—most notably a customer database 155 and a product catalog 157. These databases, discussed in greater detail below, are ordinarily stored on devices 132 and accessed as necessary. Depending on the customer's requests and interaction with server 125 via browser 115, transaction server 152 selects or causes assembly of various web pages 159 and causes web/mail server 145 to serve the pages to the client 110 via network interface 127.

Thus, server 125 is capable of facilitating retail sales over a computer network. Transaction server 152 receives and processes the orders, and generally manages the customer's interaction with the site. Transaction server 152 also maintains the customer database 155, which stores customer-identifying information (including the customer's name and postal address, e-mail address for order confirmation, and credit-card account data). The customer's record in database 155 may also include information facilitating communication via media other than the Internet, e.g., a facsimile number. Database 155 also supports, for each customer, a list 160 of contacts entered by that customer. A contact entry will generally include a name and a means of communicating with the contact (typically an e-mail address, but possibly a telephone or facsimile number, or a postal address).

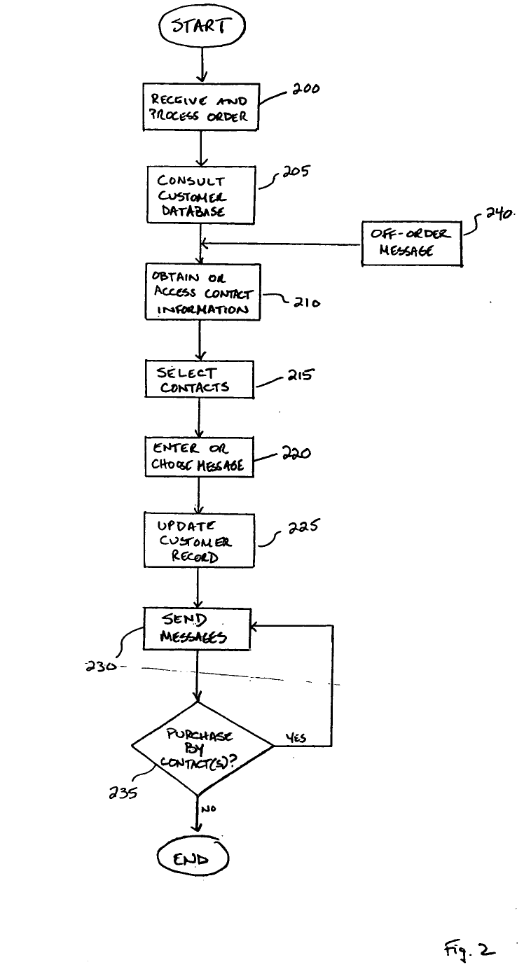

The basic operation of these components is set forth in FIG. 2. In a first step 200, the customer peruses product catalog 157 for goods and/or services of interest, and places an order via interaction with web pages 160 generated by web server 145. When the order is placed, transaction server 152 checks the customer's database record (step 205) to see if the customer is entitled to credit due to earlier successful referrals, and if so, the credit is applied to the customer's purchase.

Upon completion of the order, the customer is prompted to consider sending a message concerning the ordered item(s) to selected contacts. In step 210, web server 145 serves a web page that accords the customer access to his contact list 160. The customer may, at this time, choose to add one or more new entries to the list; data for the new entries is entered via an appropriate web page and is transmitted back to server 125, where it is stored in the customer's contact list 160 within database 155.

In step 215, a web-page form listing the customer's contact list is transmitted to the customer. The customer indicates contacts to whom a product-related message is to be sent by clicking on a check box next to each each contact name. The web page also provides a box in which the customer can enter the message. Alternatively or in addition, the customer may be allowed to select among a series of pre-written promotional messages. The customer enters or selects the desired message (step 220), and signifies completion of the form by clicking on a graphical radio button, which triggers transmission of the entered data back to server 125.

Upon receipt by server 125 of the selections and message, transaction server 145 updates the customer's database record (step 225), and the messages are sent to any designated contacts (step 230). The modes by which contacts can be reached are established by the customer when each contact is originally entered, so the customer retains some measure of control over contact communication. The customer's incentive is to create successful referrals; accordingly, the customer will designate communication modalities that will likely reach the contacts without causing annoyance. The message may be sent by any or all modalities specified in the contact entry, either at the discretion of the retailer or as indicated by the customer.

Also in step 225, a product cross-reference is entered between the customer's record and the record of each contact. In this way, if any of the contacts subsequently purchases the recommended product (step 235), a corresponding entry will be made in the customer's record so that the customer receives credit for a successful referral. The opportunity to receive credit may expire after too much time elapses between the referral and the subsequent purchase (since the likelihood that the purchase was motivated by a referral obviously diminishes over time). The credit to the customer can represent any marketing benefit designated by the retailer—e.g., a discount on the customer's subsequent purchase. In that case, the credit is applied as described above when the customer next places an order.

The customer need not submit a message contemporaneously with the order; indeed, a purchaser may hesitate to recommend a product he has not yet received. Accordingly, transaction server 152 is configured to allow for off-order messages (step 240), which may be placed at any time. For example, the retailer's home page may contain a radio button offering the option to leave a message; when the customer selects this button, a new page is served that contains his contact list appears and also facilitates designation of the product upon which he wishes to comment. At this point, the customer selects contacts and enters his comments, and the system follows the steps 210-235 as discussed above.

Moreover, the invention may permit the customer to enter comments with respect to a product sold by the retailer, but which the customer has purchased elsewhere. The customer is rewarded based on sales subsequently generated for the retailer, so the retailer is largely indifferent to the place of original purchase.

The invention is, of course, capable of implementations other than as an adjunct to a retail-sales system. For example, the system may be employed by an independent marketing company serving many retailers. In this case, the marketing company operates server 125, and the retailers' sales web pages offer hyperlinks to the customer's contact list on server 125; following the customer's interaction with the server, the server transmits the relevant information to the retailer for purposes of crediting the customer's account. Depending on the implementation, the customer may not even realize he is leaving the seller's site.

Alternatively, the site may be run completely independently of retailers, offering customers the opportunity to comment upon any products they own. For example, the server may be owned by a message-routing company whose primary business is transmission of messages via customer-designated communication modalities. In this case, the server proprietor's identity is known to the commenting customer, and the proprietor is responsible for arranging to reward the customer. It may not be feasible, in this implementation, to attempt to relate subsequent sales back to a particular customer's comments. Accordingly, the customer may be rewarded merely for submitting the comment (e.g., in the form of a coupon, accumulating points redeemable with various retailers, etc.), and retailers and/or manufacturers pay the site proprietor a promotional fee for maintaining the site.

Alternatively, where reward of a referring customer is feasible based on subsequent purchase by the recommendee—e.g., if the reward is given only for purchases made within a stated time frame, or via an order proceeding directly from the message—the server proprietor may forward both the customer's and the recommendee's identities to the retailer. This facilitates reward both of the message-sender and the server proprietor. Such an arrangement is particularly convenient for message-routing services, which may send the appropriate data to retailers on an automated basis.

The customer's message may take any of several forms. In the simplest approach, the customer simply notifies the message-routing service that he wishes to send a recommendation concerning a designated product, in which case the service notes the selected product, the customer, and the recipient. It is not necessary for the service to actually evaluate the content of the message, since the customer's reward depends on a subsequent purchase by the recipient.

The service may also allow the customer to choose among pre-written, stored messages, which are forwarded to the customer's designated recipients. To prevent customers from simply designating recipients at random, the service may inform the customer that he will be identified to the recipient(s). In related approach, the service may permit the customer to append pre-written announcements to messages that are otherwise non-promotional in nature. The announcement may, for example, identify the product and contain a URL that allows the recipient to visit a website and thereby obtain further information about the product. If the website supports e-commerce, permitting the message recipient to order the product as well, it is particularly simple for the retailer to relate the recommendee's purchase to the originating message (e.g., by embedding identifying information in the hyperlink) and thereby recognize the message-sender's role in the transaction.

It will therefore be seen that the foregoing represents a flexible, customer-friendly referral-marketing system that combines ease of use with customer incentive. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

1. An electronic commerce system for communicating with purchasers via a client machine connected to a global computer network, the system comprising:
a server for receiving and processing orders placed remotely by the purchaser, each order comprising a product;
a database, accessible to the server, comprising a record identifying (i) the purchaser, (ii) a plurality of contacts designated by the purchaser, and (iii) contact information facilitating communication with the contacts;
instructions executable on the client machine for rendering an interface thereon, the interface facilitating (i) designation of the order, (ii) designation of at least one of the contacts, and (iii) entry of a message pertaining to the order; and
a network interface for transmitting the rendering instructions to the client machine via the network,
wherein
the server is responsive to the interface so as to (i) facilitate fulfillment of the order and (ii) transmit the message to the at least one designated contact, the server further monitoring whether the at least one designated contact subsequently purchases the product to facilitate reward of the purchaser.

2-25. (canceled)
